(19) United States
(12) Patent Application Publication
(10) Pub. No.: US 2021/0208267 A1
(43) Pub. Date: Jul. 8, 2021

(54) DEVICE OPERATION MODE CHANGE

(71) Applicant: Hewlett-Packard Development Company, L.P., Spring, TX (US)

(72) Inventors: Alexander Wayne Clark, Spring, TX (US); Nick Thama, Spring, TX (US)

(73) Assignee: Hewlett-Packard Development Company, L.P., Spring, TX (US)

(21) Appl. No.: 17/047,811

(22) PCT Filed: Sep. 14, 2018
(86) PCT No.: PCT/US2018/051044

§ 371 Date: Oct. 15, 2020

(51) Int. Cl. G01S 13/42; G06F 3/16; G01S 13/88; G06F 21/62; G06F 21/84; G06N 20/00

(52) U.S. Cl. CPC G01S 13/426; G06F 3/16; G06N 20/00; G06F 21/6245; G06F 21/84; G01S 13/886

(57) ABSTRACT

Examples associated with device operation mode change are described. One example device includes a data store. The data store may store contextual data correlating spatial data with a set of operations modes for the device. The spatial data includes data describing quantities and locations of persons relative to the device. A scanner detects a set of current spatial data of the device, including current quantities and current locations of persons relative to the device. A mode change module controls the device to enter a selected operation mode based on comparing the current spatial data to the contextual data. A learning module updates the contextual data based on a user behavior in response to the device entering the selected operation mode.

### BACKGROUND

Computers today are used for a variety of purposes and in a variety of scenarios. For example, computers may be used by individuals for work and/or personal use, by groups working on a project together in person and remotely, and so forth. Computers are used for making audio and/or video calls, entertainment, learning, design, productivity, and so forth.

### BRIEF DESCRIPTION OF THE DRAWINGS

The present application may be more fully appreciated in connection with the following detailed description taken in conjunction with the accompanying drawings.

FIG. 1 illustrates example spaces associated with device operation mode change.

FIG. 2 illustrates an example device associated with device operation mode change.

FIG. 3 illustrates a flowchart of example operations associated with device operation mode change.

FIG. 4 illustrates another example device associated with device operation mode change.

FIG. 5 illustrates an example computing device in which example systems, and methods, and equivalents, may operate.

### DETAILED DESCRIPTION

Examples associated with device operation mode change are described. Because computers are used in so many situations, it may be desirable for computers to be able to guess what situation they are in, and make various operational changes to the way the computer behaves. These behavior changes may come in the form of activating or deactivating certain features, applications, components, and so forth.

In one example, a computer may use a sensor such as a radar sensor or a millimeter wave detector to identify the locations and number of persons in locations relative to the computer. Based on this information, the computer may automatically change certain aspects of how the computer is operating. This may include, for example, entering a privacy mode, changing a sound pickup mode, changing a sound projection mode, and so forth. Changing modes may also be based on, for example, a location of the device, what applications are operating on the device, and so forth.

Additionally, because different individuals use their computers in different manners, computers, individually and/or collectively, may learn operating modes of a user and/or users to better predict when modes of operation are preferred given various information. For example, while one computer may realize that persons viewing the computer from a periphery angle are likely unauthorized viewers of the screen of the computer and consequently cause the computer to enter a privacy mode, a different computer may learn that it is common for its users to work on a project together, and instead operate without entering the privacy mode.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, instructions stored on a computer-readable medium or in execution on a machine, and/or combinations of each to perform a function(s) or an action(s), and/or to cause a function or action from another module, method, and/or system. A module may include a microprocessor controlled via instructions executable by the microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

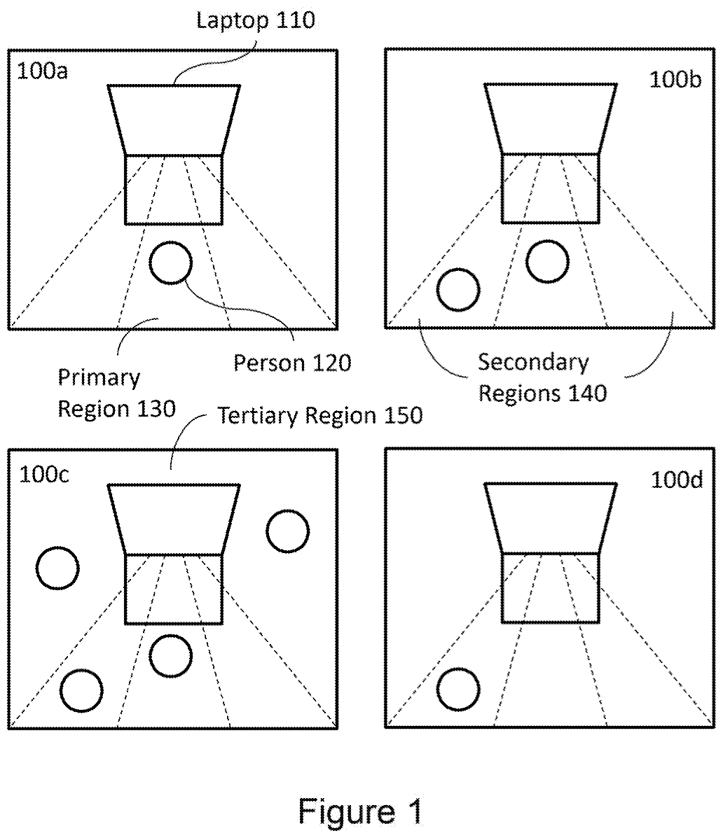

FIG. 1 illustrates an example spaces 100 (100a, 100b, 100c, and 100d) associated with device operation mode change. Each space includes a laptop 110, and a number persons 120 situated at varying locations around laptop 110. The spaces 100 are divided into four regions relative to laptop 110. The regions are divided by the dashed lines shown on the spaces 100. A primary region 130 lies substantially directly in front of laptop 110 in which, for example, a primary operator of laptop 100 may situate themselves when using laptop 110. Two secondary regions 140 encompass spaces to the left and the right of the primary region 130. For the purposes of this example, the secondary regions are intended to encompass areas of the spaces 100 that have a view of the screen of laptop 110 but are outside of a primary direct view of the screen of laptop 100. By way of illustration, a person 120 situated in a secondary region 140 may have difficulty directly operating laptop 100 without adjusting laptop 110, may not be able to easily see all portions of a screen of laptop 110, and so forth. Finally, a tertiary region 150 is intended to encompass areas around laptop 110 where the screen of the laptop is harder to view.

It should be appreciated that the regions listed here are used for illustrative purposes and that many different configurations of regions, or no regions may be used. Additionally, instead of regions, techniques used herein may operate using coordinate locations of persons within a two-dimension of three-dimension space relative to laptop 110. Thus, techniques herein may operate effectively using a greater or lesser number of regions, using no regions, using specific locations of users, and so forth. Regions may also be based, for example, on factors including distance, angular position from a screen of laptop 110, audio concerns based on where users are relative to speakers and/or microphones, and so forth.

To select between operating modes, laptop 110 may include a sensor and set of contextual data, The sensor may be, for example, a radar, a millimeter wave detector, and/or other sensors that can distinguish between humans and their surroundings. The sensor may be used to detect quantities of persons 120 situated around laptop 110, as well as the positions of person 120 relative to laptop 110. The contextual data may correlate various configurations of persons situated around laptop 110 with a set of operating modes for laptop 110. In one example, the contextual data may be generated based on machine learning techniques that takes a variety of input factors and outputs a result that can be used to control various aspects of laptop 110. Additionally, as laptop 110 is used over time, laptop 110 may update the contextual data to learn situations where various modes should be entered. These modes may be different from device to device as the manner in which devices are used may vary between users. In addition to locations and quantities of persons relative to laptop 110, the contextual data may also include other information. The location may relate to, for example, a physical location of a device gathered based on GPS sensor data and/or other nearby devices (e.g., wireless networks), authenticated users of laptop 110 determined based on proximity of another device (e.g., cell phone) associated with an authenticated user to laptop 110, what applications are being used (e.g., a proprietary application, a conferencing application, a learning application), and so forth.

As discussed above, laptop 110 may have a variety of operating modes. The operating modes may be characterized by different software configurations, hardware configurations, and so forth, For the purposes of this example, four operating modes will be discussed, one for each space 100. However, as techniques described herein relate to devices learning situations the device should shift between different operating modes, different devices may learn differently depending how the devices is used.

Space 100a includes a single person 120 situated in primary region 130 relative to laptop 110. This situation where a single user is situated around laptop 110 and no other persons 120 can be detected within a predefined distance of laptop 110. This may be because, for example, the person 120 is using laptop 110 in a workspace without anyone else in the immediate vicinity. In this example, laptop 110 may operate in a mode that is predicted to be usable by a single user. For example, features of other modes described below relating to audio conferencing, privacy, and so forth, may not be enabled. Instead, features of laptop 110 may be configured to support the use of a single user. These features may include audio settings, display settings and so forth.

Space 110b illustrates a situation where a second person 120 has entered a secondary region 140 in addition to the person 120 in primary region 130 relative to laptop 110. This may occur when, for example, a user is in a public space and a second person sits down next to them, when a coworker approaches a primary user's desk to ask a question, and so forth. In this example, laptop 110 may enter a privacy mode to prevent people outside of primary region 130 from viewing the screen of laptop 110. The privacy mode may make so persons having a non-front angle view of laptop 110 have a greyed out or blacked out view of the contents of the screen of laptop 110. While using the privacy mode may be desirable to prevent unwanted viewing of the screen of laptop 110, other factors may prefer that the privacy mode be generally disabled such as, for example, battery usage, applications being used, and so forth.

Space 100c illustrates a situation where there are several users around laptop 110 including two persons 120 in tertiary region 150. This may occur, for example, when laptop 110 is being used for a multiple person conference. In this scenario, laptop 110 may configure various components to better project audio and record voice from persons 120 throughout space 100c. For example, upon detecting a conferencing scenario, laptop 110 may increase the volume of sound projected from speakers of laptop 110, increase the pickup of a microphone of laptop 110, adjust device settings to reduce feedback, reverb, background noise, and/or other audio issues, and so forth.

Space 100d illustrates a situation where a single person 120 is in secondary region 140 relative to laptop 110. This may occur when a person is moving around throughout space 100d, for example, giving a presentation or dictating to laptop 110. In this example, laptop 110 may configure audio settings to follow the voice of the person 120 and cancel audio picked up from other areas of space 110d.

In some examples, upon changing modes, device 110 may provide an alert to a user of device 110. This alert may be, for example, a small box that pops up on the screen of laptop 110 to notify the user that laptop 110 is changing certain settings. The alert, in addition to providing information to the user of laptop 110, may also provide the user a point of interaction to revert the mode change or to otherwise modify settings related to the mode change. By way of illustration, if laptop 110 detects a scenario similar to space 100b and enters a privacy mode. After alerting the user of the setting change, the user may interact with the alert to inform laptop 110 that the contents of the screen of laptop 110 do not need to be hidden from the other person 120 in space 100b.

Additionally, after a mode change, it may be desirable for laptop 110 to learn from user behavior about when mode changes should be performed in the future. For example, if a user reverts a mode change by interacting with an alert in a certain set of circumstances, laptop 110 may be less likely to perform a similar mode change under similar circumstances in the future. Laptop 110 may learn from user behavior by updating stored contextual data under other circumstances as well. For example, laptop 110 may learn when to change modes based on a user manually turning a mode on or off, by a user affirmatively or passively agreeing to a mode change, and so forth. A user may affirmatively agree to a mode change by confirming the alert. A user may passively agree to a mode change by continuing to use the laptop after receiving the alert for a predefined period of time. In some examples, it may also be desirable for laptop 110 to share non-personal data with other devices about when to perform mode changes. This may allow a stronger repository of mode change data to be built to better serve users in the future. Thus, laptop 110 may share certain data with a remote service, and receive updated data from the remote service in response. However, laptop 110 may prioritize data it has gathered based on its own user over general data received from the remote service that may relate to an average or gen user.

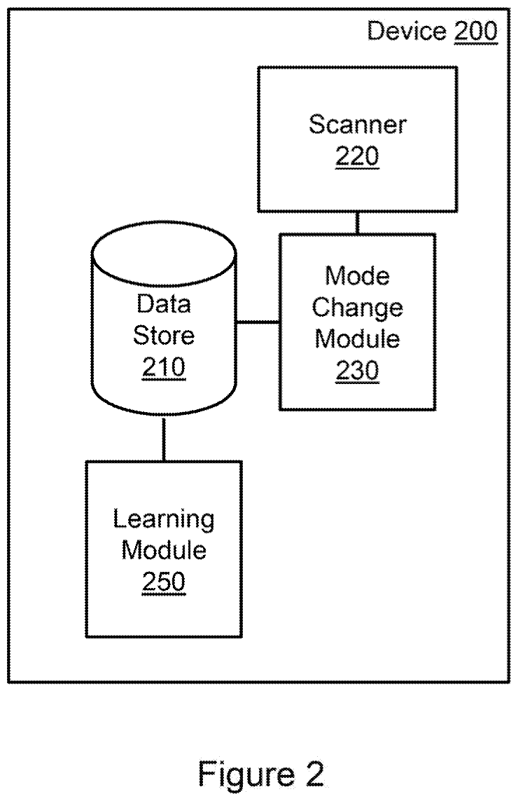

FIG. 2 illustrates a system 200 associated with device operation mode change. System 200 includes a data store 210. Data store 210 may store contextual data. The contextual data may correlate spatial data with a set of operation modes far device 200. The spatial data may include data describing quantities and locations of persons relative to the device. The spatial data may also include data describing a location of device 200, data describing applications in use on device 200, and so forth.

System 200 also includes a scanner 220. Scanner 220 may be, for example, a radar scanner, a millimeter wave detector, and so forth. Scanner 220 may detect a set of current spatial data of device 200. The current spatial data may include current quantities and current locations of persons relative to device 200.

System 200 also includes a mode change module 230. Mode change module 230 may control device 200 to enter a selected operation mode. The selected operation mode may be entered based on comparing the current spatial data to the contextual data. The selected operation mode may be, for example, a privacy mode. The selected operation mode may be an audio mode. The audio mode may be, for example, a single user mode, a conference audio mode, a noise cancellation mode, and so forth.

Device 200 also includes a learning module 250. Learning module 250 may update the contextual data based on a user behavior in response to device 200 entering the selected operation module. By way of illustration, in some examples, mode change module 230 may cause an alert to a user of device 200. In this example, learning module 250 may update the contextual data based on a user interaction with the alert, an action taken after the alert that is non-interactive with the alert. In an another example, learning module 250 may update the contextual data based on a user interaction with a setting of device 200.

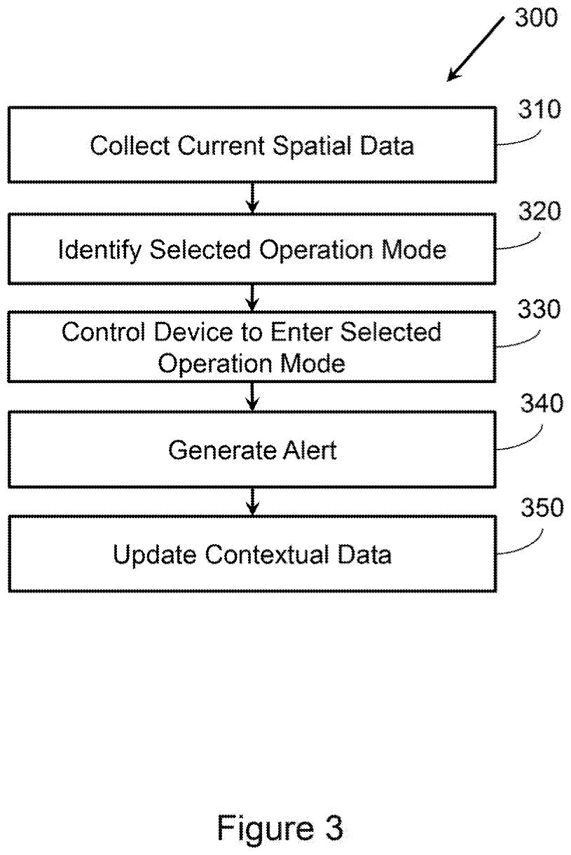

FIG. 3 illustrates an example method 300. Method 300 may be embodied on a non-transitory processor-readable medium storing processor-executable instructions. The instructions, when executed by a processor, may cause the processor to perform method 300. In other examples, method 300 may exist within logic gates and/or RAM of an application specific integrated circuit (ASIC).

Method 300 may perform various tasks associated with device operation mode change. Method 300 includes collecting a set of current spatial data at 310. In some examples, the current spatial data may be collected using a radar scanner, a millimeter wave detector, and so forth. The current spatial data may describe locations and quantities of persons relative to a device. The current spatial data may also include data describing a location of a device. The location may be gathered using sensors embedded in the device. The location data may be gathered based on, for example, a GPS sensor, sensors that detect wireless networks to determine if frequently observed wireless networks are present, and so forth.

Method 300 also includes identifying a selected operation mode at 320. The selected operation mode may be identified by comparing the current spatial data to a set of contextual data. The contextual data may correlate historical spatial data with operation modes of the device.

Method 300 also includes controlling the device to enter the selected operation mode at 330. Entering the selected mode may involve, for example controlling settings of the device, activating and/or deactivating features of the device, initiating and/or terminating applications, and so forth.

Method 300 also includes generating an alert at 340. The alert may be provided to a user of the device and may relate to the selected operation mode. Method 300 also includes updating the contextual data at 350. The contextual data may be based on a user interaction, The user interaction may be, for example, an interaction with the alert, a change to an operation mode, a continued use of the device for a predefined period after the alert, and so forth.

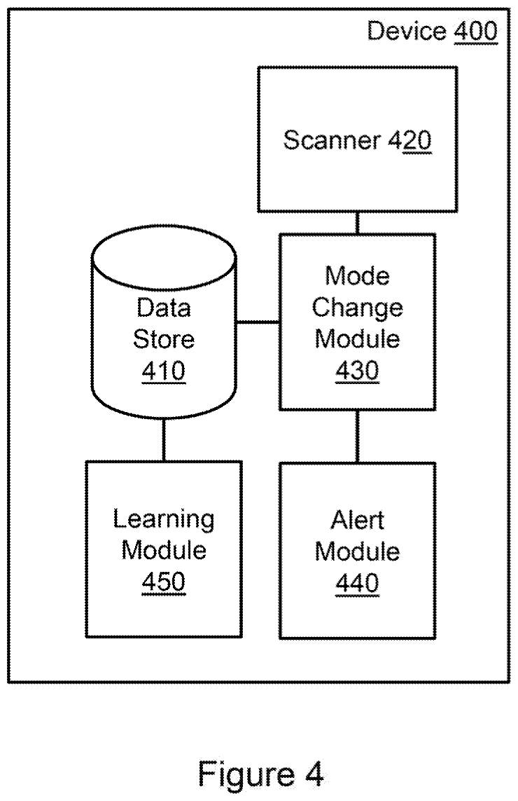

FIG. 4 illustrates a device 400 associated with device operation mode change. Device 400 includes a data store 410, Data store 410 may store contextual data correlating spatial data with a set of operation modes for device 400. The spatial data may include data describing quantities and locations of persons relative to device 400. The operating modes may be associated with component settings for hardware components of device 400.

Device 400 also includes a scanner 420. Scanner 420 may detect a current spatial data of device 400. The current spatial data may describe current locations and current quantities of persons relative to device 400. The current spatial data may monitor within a predefined distance of device 400.

Device 400 also includes a mode change module 430. Mode change module 430 may select a selected operation mode for device 400. The selected operation mode may be selected by comparing the current spatial data to the contextual data. Mode change module 430 may control component settings of the hardware components of device 400 based on the selected operation mode.

Device 400 also includes an alert module 440. Alert module may generate an alert to a user in response to mode change module 430 controlling component settings.

Device 400 also includes a learning module 450. Learning module 450 may update the contextual data in data store 410 based on user actions taken during a predefined time period around the alert, and based on user actions taken to change an operation mode of device 400.

In some examples, device 400 may include an update module (not shown). The update module may provide data describing updates made to the contextual data (e.g., by learning module 450) to a remote service. The update module may also receive updated contextual data from the remote service.

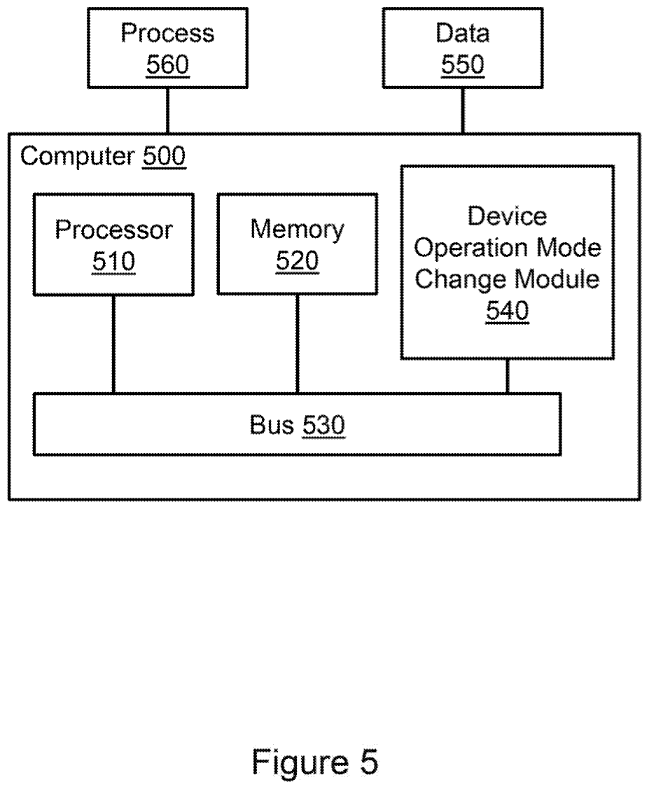

FIG. 5 illustrates an, example computing device in which example systems and methods, and equivalents, may operate. The example computing device lay be a computer 500 that includes a processor 510 and a memory 520 connected by a bus 530. Computer 500 includes a device operation mode change module 540. Device operation mode change module 540 may perform, alone or in combination, various functions described above with reference to the example systems, methods, and so forth. In different examples, device operation mode change module 540 may be implemented as a non-transitory computer-readable medium storing processor-executable instructions, in hardware, as an application specific integrated circuit, and/or combinations thereof.

The instructions may also be presented to computer 500 as data 550 and/or process 560 that are temporarily stored in memory 520 and then executed by processor 510. The processor 510 may be a variety of processors including dual microprocessor and other multi-processor architectures. Memory 520 may include non-volatile memory (e.g., read-only memory, flash memory, memristor) and/or volatile memory (e.g., random access memory). Memory 520 may also be, for example, a magnetic disk drive, a solid state disk drive, a floppy disk drive, a tape drive, a flash memory card, an optical disk, and so on. Thus, memory 520 may store process 560 and/or data 550. Computer 500 may also be associated with other devices including other computers, devices, peripherals, and so forth in numerous configurations (not shown).

It is appreciated that the previous description of the disclosed examples is provided to enable any person skilled in the art to make or use the present disclosure. Various modifications to these examples will be readily apparent to those skilled, in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A device, comprising:
a data store to store contextual data correlating spatial data with a set of operation modes for the device, where the spatial data includes data describing quantities and locations of persons relative to the device;
a scanner to detect a set of current spatial data of the device, including current quantities and current locations of persons relative to the device;
a mode change module to control the device to enter a selected operation mode based on comparing the current spatial data to the contextual data; and
a learning module to update the contextual data based on a user behavior in response to the device entering the selected operation mode.

2. The device of claim 1, where the selected operation mode a privacy mode.

3. The device of claim 1, where the selected operation mode is an audio mode.

4. The device of claim 3, where the audio mode is one of a single user mode, a conference audio mode, and a noise cancellation mode.

5. The device of claim 1, where the mode change module causes an alert to a user of the device, and where the learning module updates the contextual data based on one of, a user interaction with the alert, and an action taken after the alert that is non-interactive with the alert.

6. The device of claim 1, where the learning module also updates the contextual data based on a user interaction with a setting of the device.

7. The device of claim 1, where the spatial data also includes data describing a location of the device.

8. The device of claim 1, where the scanner is one of a radar scanner and a millimeter wave detector.

9. The device of claim 1, where the spatial data also includes data describing applications in use on the device.

10. A method, comprising:
collecting a set of current spatial data describing locations and quantities of persons relative to a device;
identifying a selected operation mode by comparing the current spatial data to a set of contextual data that correlates historical spatial, data with operation modes of the device;
controlling the device to enter the selected operation mode;
generating an alert to a user of the device regarding the selected operation mode; and
updating the contextual data based on a user interaction

11. The method of claim 10, where the user interaction is one of, an interaction with the alert, a change to an operation mode, and a continued use of the device for a predefined period after the alert.

12. The method of claim 10, where the set of current spatial data is collected using a radar scanner, and a millimeter wave detector.

13. The method of claim 10, where the rent spatial data also includes data describing a location of a device that is gathered using sensors embedded in the device.

14. A device, comprising:
a data store to store contextual data correlating spatial data with a set of operation modes for the device, where the spatial data includes data describing quantities and locations of persons relative to the device, and where the operating modes are associated with component settings for hardware components of the device;
a scanner to detect a current spatial data of the device, where the current spatial data describes current locations and current quantities of persons relative to the device within a predefined distance of the device;
a mode change module to select a selected operation mode for the device by comparing the current spatial data to the contextual data, and to control component settings of the hardware components of the device based on the selected operation mode;
an alert module to generate an alert to a user in response to the mode change module controlling component settings; and
a learning module to update the contextual data based on user actions taken during a predefined time period around the alert, and based on user actions taken to change an operation mode of the device.

15. The device of claim 14, where the device further comprises an update module to provide data describing updates made to the contextual data by the learning module to a remote service, and to receive updated contextual data from the remote service.
